(19) United States
(12) Patent Application Publication
(10) Pub. No.: US 2006/0243110 A1
(43) Pub. Date: Nov. 2, 2006

(54) Apparatus for removing a sample from an array of samples and a cutting tool for use with that apparatus

(75) Inventors: Dirk Ostermann, South Australia (AU); Cheng Hong Bing, South Australia (AU); Pieter Faber, South Australia (AU); George Kraguljac, South Australia (AU); Andrew Arthur Gooley, New South Wales (AU)

Correspondence Address: MORGAN LEWIS & BOCKIUS LLP, 1111 PENNSYLVANIA AVENUE NW, WASHINGTON, DC, 20004, US

(73) Assignee: Macquarie Research Ltd., New South Wales (AU)

(21) Appl. No.: 11/409,271

(22) Filed: Apr. 24, 2006

Related U.S. Application Data
(63) Continuation of application No. 11/220,404, filed on Sep. 7, 2005, now abandoned.
Application No. 11/220,404 is a continuation of application No. 09/509,215, filed on Feb. 7, 2001, now abandoned.

(30) Foreign Application Priority Data
Sep. 25, 1997 (AU) PO 9438
May 20, 1998 (AU) PP 3615

(51) Int. Cl. B26F 1/14

(52) U.S. Cl. 83/128; 83/686

(57) ABSTRACT

A sampling device includes a table (12) and an overhead beam (14) which is spaced and supported above the table by two columns (16, 18). In the center of the beam, a cutting tool (20) assembly is located. The table is mounted so as to be moveable in the x and y directions in a generally horizontal plane. By moving the table in the x and y directions, any part of the table may be located under the cutting tool assembly. A computerized controller includes a digital scanner to record an image of an array of samples on the table and control the cutting tool to cause it to cut out a sample from the array, pick it up and transfer it to a selected location.

### TECHNICAL FIELD

The present invention relates to a apparatus for removing one or more samples from an array of samples and to a cutting tool for use with that apparatus. In particular, the invention relates to an apparatus for excising and ejecting biomolecules from an array of biomolecule samples in a gel or solid support.

### BACKGROUND ART

Improvements in laboratory techniques and practices have led to the discovery of an ever increasing number of new biomolecules. New protein purification and detection methods, for example, have allowed the detection of many possibly new proteins. Due to the large number of known biomolecules, it is now necessary to carry out molecular comparisons of newly discovered molecules to determine to what extent they are similar to, or different from, known molecules. For example, to carry out definitive analysis for proteins it is necessary to obtain amino acid sequence information or determine the masses of peptides after protein digestion. Often, the biomolecules are separated by electrophoresis in polymer based media. Thus the biomolecules for analysis are usually present as “concentrated” spots on media such as dry polymer membranes or wet gels. It is necessary to excise the biomolecule from the media and transfer them separately to a vessel such as a microtitre plate to carry out analysis of the biomolecules. The spots are usually cut out by a laboratory worker or researcher using a scalpel and are placed in a test tube for analysis by application of a reagent or succession of reagents to the sample. Typically a single membrane may have many hundreds or thousands of spots of biomolecules. Multiple sample handling using laboratory techniques can be labor intensive, prone to error and contamination. At the same time, the improvements in laboratory techniques and practises and the discovery of an ever increasing number of new biomolecules have increased the need for analysis of sample biomolecules.

WO 97/29355 discloses a process and an apparatus for effecting contactless transfer of special compounds into biological objects, typically cells, located on a polymer carrier film by laser microinjection. The laser is also used to cut out the object, by cutting around it. The laser is a U-V laser and the polymer film is a special U-V absorbing polymer film. The sample is then impelled by the laser beam to an adjacent adhesive collecting film. The collecting film has to be located between 1 and 10 mm from the polymer film, preferably 1-3 mm. Locating the sample to be cut out is done by fluorescence microscopy which produces an image of the table on which the carrier film is located to enable the laser to be guided for injection and cutting. The process and apparatus described in WO 97129355 is complicated, and is awkward to use as it requires an adjacent collecting film for catching the excised sample. The apparatus is only suitable for use with thin materials such as histology sections which are typically several microns thick. Further, the sample still has to be removed from the collecting film for analysis, and the requirement for an adhesive on the collecting film may contaminate the sample.

The present invention seeks to overcome or at least ameliorate some of the problems associated with the background art discussed above.

### SUMMARY OF THE INVENTION

In a first broad aspect, the present invention relates to a method for excising at least one sample in an array of samples comprising:

(a) recording an electronic image of the position of at least one sample relative to the other samples in the array:

(b) utilising the recorded image to control a cutting tool to excise the at least one sample:

(c) picking up and the excised sample in the cutting tool retaining the same in the cutting tool and moving the cutting tool relative to a selected location; and

(d) depositing the at least one excised sample at the selected location.

The steps (a) to (d) may be repeated or cycled so as to carry out a series of excisions of a number of different samples in the array.

The samples may be separated into the array by known means such as electrophoresis in a polymer matrix. Samples may be transferred from the polymer matrix onto a solid support or membrane support. For example, two dimensional electrophoresis separations in polyacrylamide are transferred to supports like PTFE, gortex, PVDF, nylon, nitrocellulose, polypropylene which are particularly suitable for supporting an array of samples for excision using the methods and apparatus of the present invention. Samples may also be excised without having to transfer them to a membrane.

In a related broad aspect, the present invention relates to an apparatus for excising at least one sample from an array of samples comprising:

(a) means for recording an electronic image of the position of at least one sample relative to the other samples in the array;

(b) means for utilising the recorded electronic image to control a cutting tool to excise the at least one sample from the array and retain the sample in the tool;

(c) means for moving the cutting tool relative to a selected location; and

(d) means for causing the cutting tool to deposit the at least one excised sample at the selected location;

the arrangement being such that means (b) causes the cutting tool to excise the at least one sample according to the position of the sample relative to the other samples in the array as determined by means (a).

The sampling device may further include:

e) a table means for supporting the array of samples;

f) display means for displaying the electronic image of the array on a screen or the like;

g) means for selecting a sample on the array for sampling by the cutting tool;

h) means for moving the cutting tool in the plane of the array.

Typically, the array of samples will be present as a non-ordered array of spots on dry polymer membranes or wet gels.

The sample will preferably be of a biological nature and may include proteins, peptides, polysaccharides, lipids and nucleic acid molecules or complex molecules like glycoproteins, for example.

The means for recording an electronic image of at least a part of the array of samples may be a digital camera which makes a digital photograph of the samples. In order to generate an electronic image of the samples in the array, it is necessary to make them identifiable in some manner. Thus the electronic image may be generated from a scan of the samples stained or illuminated or otherwise marked with a visible or fluorescent marker to allow them to be visualised. An ink jet dispensing unit, such as is disclosed in applicants co-pending International patent application No PCT/AU98/00265, the entire contents of which are incorporated herein by reference, could be used for marking the spots/samples. Once the electronic image has been recorded in a computer or the like there is no need to maintain the visualisation of the samples on the array as the image may be maintained electronically.

The coordinates of the samples are recorded. These coordinates are then transformed into robotic language and the computer used to control a cutting tool whereupon the cutting tool can be directed to a selected sample. The position of all the samples would be known from their co-ordinates on the grid, and so excision is possible regardless of whether or not the samples are still visible. Once excised the cutting tool moves to a selected coordinate of a well of a microtitre plate or the like and the sample is ejected

In a preferred embodiment an image file relating to a number of arrays of samples is stored on the computer. An image of a particular array is displayed on the computer and spots are selected from the array to be sampled using the computer monitor and a mouse. Once a mouse is clicked on a particular spot the cutting tool will automatically move to that spot, cut the spot from the array, pick up the spot and transport it to the selected well, or the like.

In a preferred embodiment the array of samples is in a plane, the x-y plane, and the table means is movable in both the x and y directions so that the spot to be sampled is placed underneath the cutting tool.

Alternatively, it would be possible to have the table means fixed and the cutting tool movable.

In a particular embodiment of the present invention a cutting tool for use in the apparatus and method of the present invention comprises:

a cutting head defining a central bore adapted to cut and retain a sample of material; and

a plunger disposed in the bore defining a rod which is disposed in and movable along the bore, the plunger being either formed of a ferro-magnetic material or having a portion of ferro-magnetic material attached thereto;

a solenoid disposed around the plunger or electromagnetic material, wherein operation of the solenoid causes the plunger to move to eject the spot from the cutting head.

The punch may be circular.

In one embodiment the cutting device is pneumatically operated.

In an alternative preferred embodiment the cutting tool comprises:

(a) a cutting tip means having a bore therethrough;

(b) a cutting tip holder for holding the cutting tip means;

(c) an ejector pin one end of which is disposed in bore of the cutting tip, the pin being moveable along the bore of the cutting tip:

(d) a magnet or a piece of ferromagnetic material attached to the ejector pin distal from the one end;

(e) a solenoid disposed around the magnet or ferro magnetic material for causing the pin to move in the bore in a direction which expels material from the cutting tip when the solenoid is energised: and

(f) return means for causing the pin to move in the opposite direction when the solenoid is not energised.

If item (d) is a magnet the return means may also be a magnet. The return means may also be a spring.

Preferably the cutting tip is removable and disposable.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF THE DRAWINGS

The invention will now be described by way of example only and with reference to the accompanying drawings in which:

FIG. 1 is a front view of a first sampling device embodying the present invention;

FIG. 2 is an enlarged front view of a cutting tool assembly which forms part of the sampling device of FIG. 1;

FIG. 3 is a side view of the cutting tool assembly shown in FIG. 2;

FIGS. 4 and 5 are detailed views of the cutting head of the cutting tool assembly, where 4 shows a sample pick-up and 5 a sample eject;

FIGS. 6a to 6h show the sequence of operation of the cutting tool assembly showing in sequence the cutting of a sample from an array of samples and the placing of that cut sample in a test tube;

FIG. 7 shows a schematic of the electronic recording and sample excision robot aspects of a second apparatus according to the present invention;

FIG. 8a shows a second embodiment of an excision tool; and

FIG. 8b shows a third embodiment of an excision tool.

### DETAILED DESCRIPTION OF THE PREFERRED EMBODIMENTS

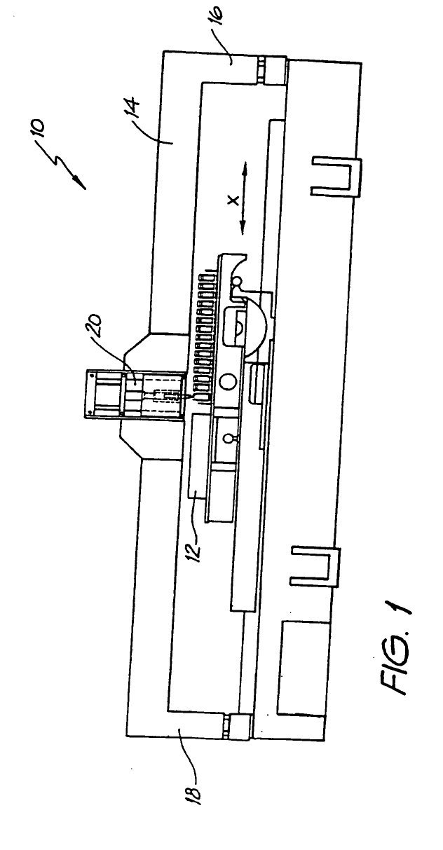

Referring to the drawings, FIG. 1 shows a sampling device embodying the present invention generally indicated at 10. The sampling device includes a table 12 and a overhead beam 14 which is spaced and supported above the table by two columns 16 and 18. In the centre of the beam a cutting tool assembly 20 is located which is described in more detail below. The table 12 is mounted so as to be moveable in the x and y directions in a generally horizontal plane. By moving the table in the x and y directions any part of the table may be located under the cutting tool assembly 20. Motors and control means, not illustrated, are provided for moving the table. The specific means for moving the table in the x and y directions is riot essential to the present invention.

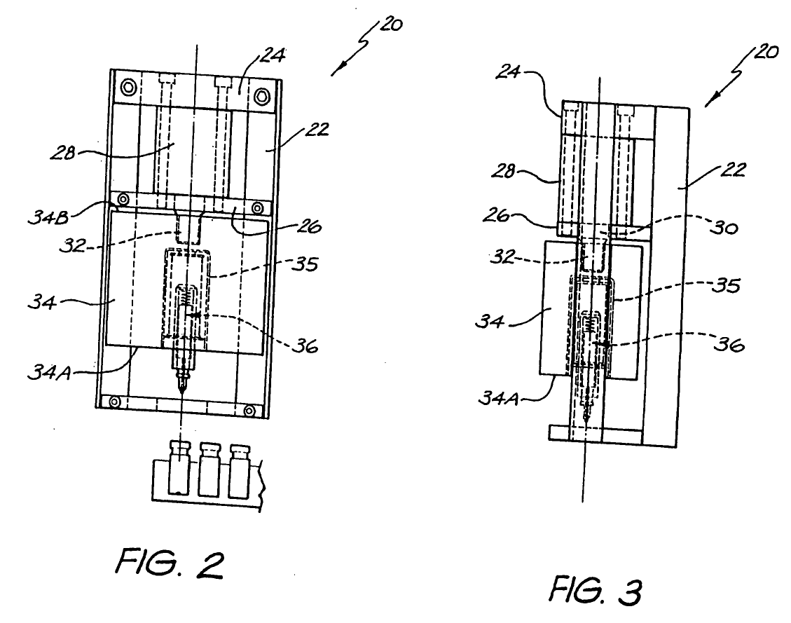

FIG. 2 and FIG. 3 show an enlarged front view and side view respectively of the cutting tool assembly. The cutting tool assembly 20 is supported on a guide means 22 which maintains the components of the assembly in their correct orientation. At the upper end of the cutting tool assembly there is a top cylinder plate 24 which is horizontally oriented. Spaced below and parallel to, the top cylinder plate there is a bottom cylinder plate 26. A cylinder 28 is disposed and extends between the two plates. The cylinder forms part of a pneumatic piston and cylinder arrangement which includes a piston rod 30 shown in phantom in FIG. 3, disposed in the cylinder 28. The depending free end 32 of the piston rod is fixed to a nylon block which defines a punch carriage 34 disposed directly below the bottom cylinder plate 26. Movement of the piston rod 30 in the cylinder 28 in the vertical (z axis) direction causes the punch carriage 34 to move in the vertical direction guided by guide rods. Movement of the piston in the cylinder is pneumatically controlled.

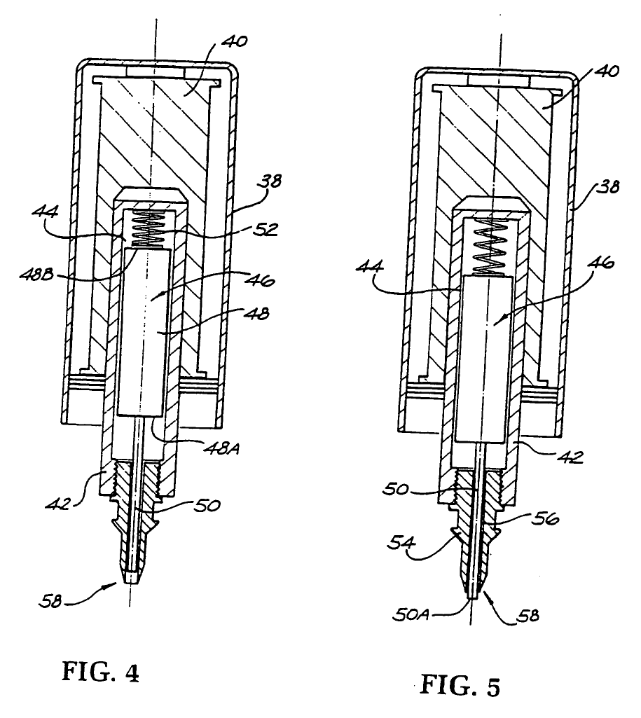

The punch carriage 34 defines a cylindrical aperture or bore 35 which extends up from the lower face 34A of the punch carriage, towards the piston rod 30 and the upper end 34B of the punch carriage. A cutting head assembly generally indicated at 36 is disposed inside that aperture 35 and is shown in more detail in FIGS. 4 and 5.

Turning now to FIGS. 4 and 5, a solenoid 38 is disposed in the interior of the aperture 35. A generally cylindrical nylon block 40 is fixed in the centre of the aperture 35 with its longitudinal axis directly in line with the piston rod 30. A punch holder 42 is disposed inside a central bore of the block 40. The punch holder defines a central bore 44 in which a steel plunger 46 is located. The plunger 46 is generally cylindrical and defines a large diameter body portion 48 from one lower end 48A of which there depends a narrower cylindrical rod 50. A spring 52 is disposed between the opposite or upper end 48B of the plunger and the tipper end of the central bore 44.

A punch 54 is fixed to the lower end of the punch holder/cutting head assembly. A generally cylindrical bore 56 extends through the centre of the punch 54. The cylindrical rod 50 of the plunger is disposed in that bore. The rod 50 is coated with a low friction material such as TEFLON™ or ACETYL™ both as a barrier to prevent residue from previously picked up samples from contaminating subsequently taken samples and to reduce friction between the rod 50 and bore 56. The lower end of the punch defines a generally circular cutting blade or tip 58, similar to a cookie cutter. As can be seen from a comparison of FIGS. 4 and 5, when the cutting head is in a “pick up” position the end of the rod 50 is withdrawn into the plunger and the end of the plunger defines a cavity which can receive a portion of material cut from the array by the cutting blade 58 of the plunger.

In FIG. 5 illustrates that when the rod 46 is moved sufficiently towards the punch 54 the distal or lower end 50A of the rod/plunger extends beyond the end of the punch 54 thus ejecting any material located in the end of the punch.

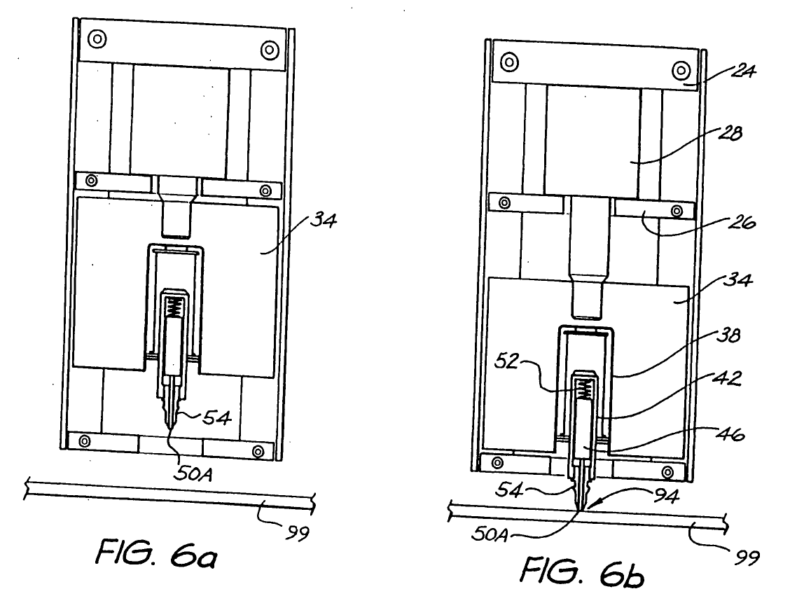

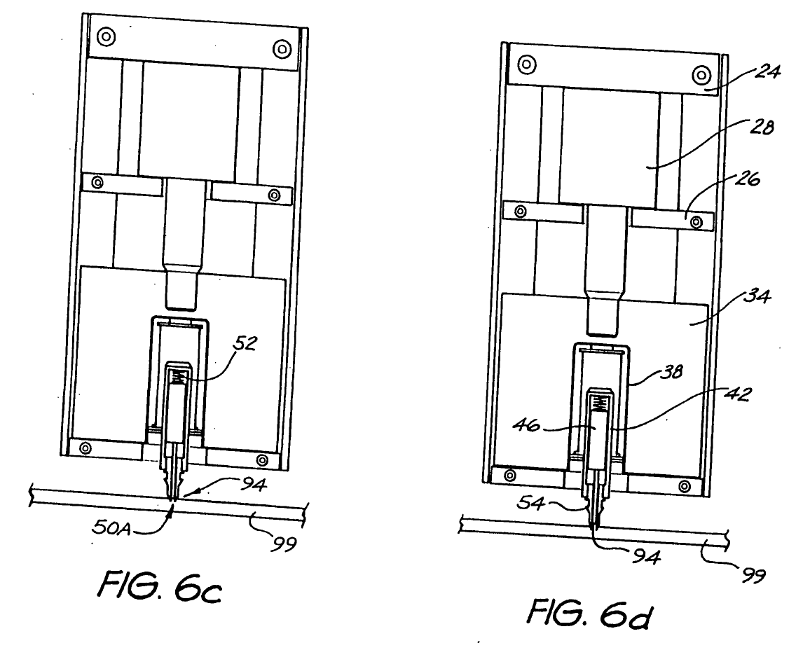

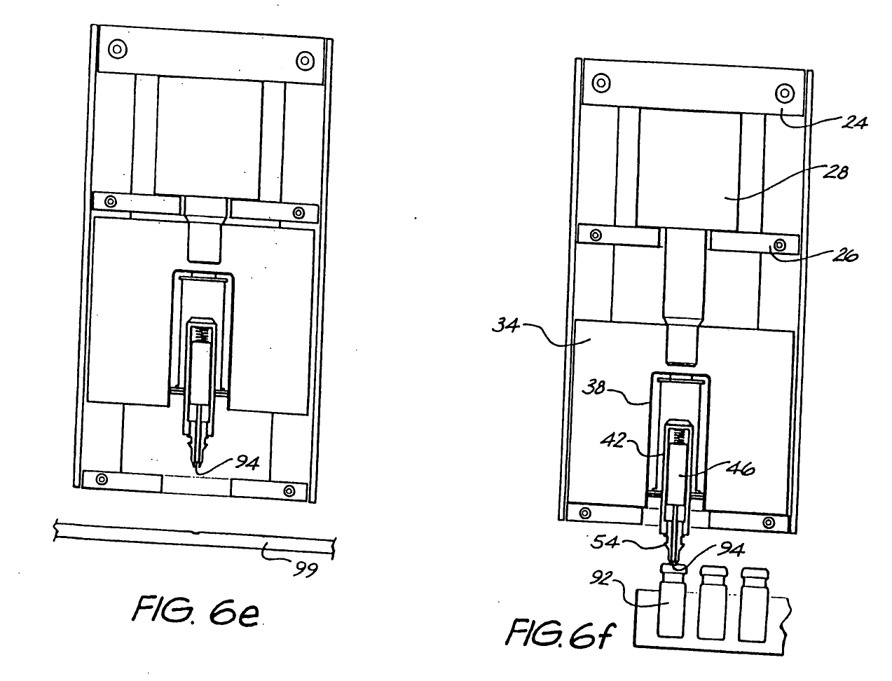

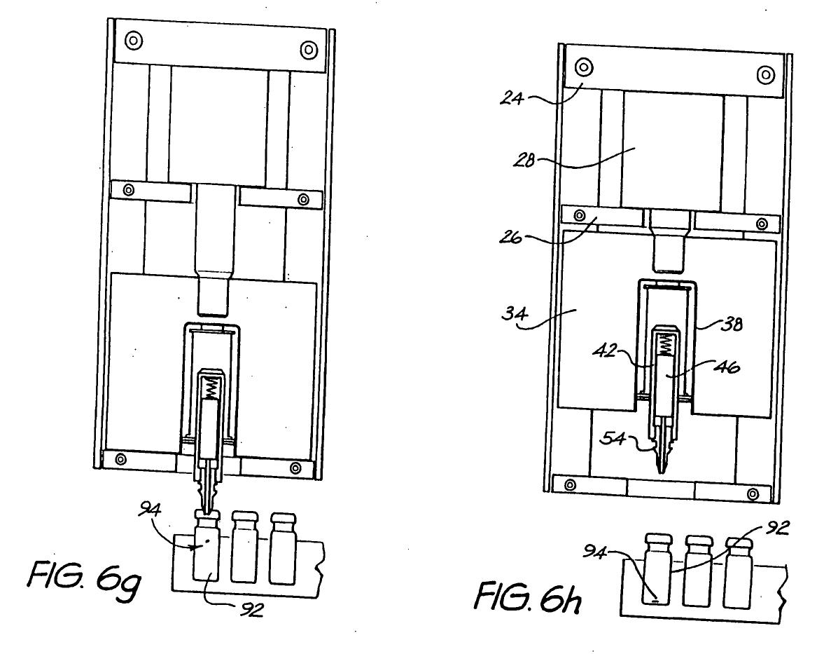

FIGS. 6a to 6h show the cutting and transfer sequence of the sampling device of the present invention in sequence in more detail. As shown in FIG. 6a initially the cutting head is disposed above a particular spot which is to be cut out from, for example, a solid (i.e. non-gel) support which may be an immobilisation membrane. The punch carriage 34 is located at the upper end of its travel and the end 50A of the plunger projects beyond the end of the punch 54.

Once the cutting head has been positioned above the correct spot, the punch carriage is operated by the pneumatic piston and cylinder assembly to push the cutting head downwards until the end 50A of the plunger touches the spot/sample to be cut. This contact secures the spot 94 and ensures it does not move. Further pressure exerted by the pneumatic cylinder will, as shown in FIG. 6c, cause the punch to move relative to the plunger and cut the spot 94 away from the surrounding membrane, while compressing the spring 52. The plunger retracts and retains the cut sample in the manner of a vacuum pick up.

Once a spot has been collected in the cutting head assembly with the plunger retracted, as seen in FIG. 6e, the table is then moved by the control means to position a test tube 92 below the cutting head, see FIG. 6f.

Once the test tube 92 or a sample bottle or the like is positioned below the cutting head, the cutting head is moved downwards towards the test tube so that the plunger is positioned inside the test tube.

The plunger is then pushed downwards by activating the solenoid which causes the plunger to move downwards and eject the sample 94.

Once the sample has been ejected into the correct test tube the cutting head will then automatically move to cut the next sample.

The procedure is slightly different when cutting a spot from a sheet of gel to allow for the fact that gel is easily squashed. In the first stage of the procedure, when the punch head is lowered to contact the gel, the plunger is retracted. This prevents squashing of the gel which would occur if the end 50A projected below the punch and were forced onto the gel. The procedure for ejecting the gel spot is different also. After the cutting head has been positioned in the test tube lifting of the head is commenced fractionally (say 1 ms) before the solenoid is activated to eject the gel spot, also to prevent squashing the spot.

The device also includes a digital camera adapted to create an image of the gel or membrane on which the spots are located and stole them in a computer. The computer is programmed with software which takes account of the distortions produced by the digital camera when imaging the array and produces a sufficiently accurate distortion free map of the array which accords with the mechanical frame used to control the cutting head assembly. There is also no need for the gel or membrane to be exactly planar. Different programs are provided for gel and non-gel arrays to account for the slightly different procedures described above.

When it is desired to select a spot, the image of the array can be displayed on a computer monitor and a mouse moved by an operator to identify the correct spot to be sampled by the sampling device.

Thus the present invention allows a vary laborious job of a researcher individually cutting spots from a gel or support using a scalpel and allows the operation to be carried out automatically.

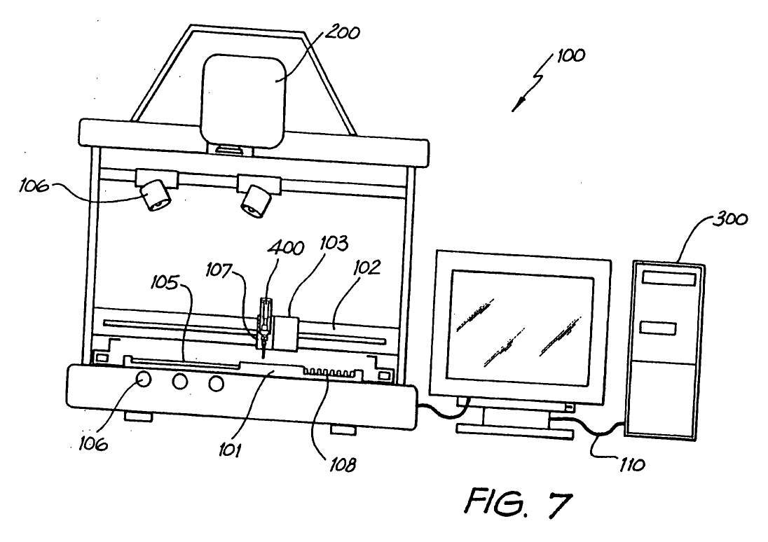

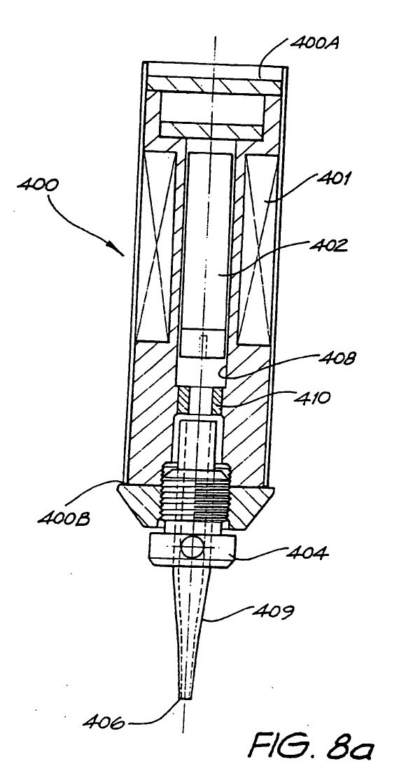

Turning now to the drawings, FIG. 7 shows a schematic representation of a second embodiment of a robotic excision apparatus. The robotic excision apparatus 100 includes an image acquisition system 200 which includes a camera, an excision tool 400, and a computer 300. An array of samples is placed onto a silicon mat 105 which is housed inside an acrylic base plate 101 which is illuminated from underneath the sample with fluorescent light (for acrylamide) or from above with tungsten lamps or a camera flash (for membranes) 106. The image is transferred from the image acquisition means to the computer 300. The image is processed and imported into “click-on-a-spot” software. This process translates the image pixel coordinates into robot coordinates. The “click-on-a-spot” software is then used to drive the excision tool 400 to the selected component via an xy movable bar 102. The z movement of the excision tool 400 is via an excision tool support unit 107. The excision tool 400, which is described in more detail below, then cuts out and holds the selected sample and moves above a specific well of a microtitre plate into which the sample is to be placed. The excised sample is then deposited into the specific well of the microtitre plate 108.

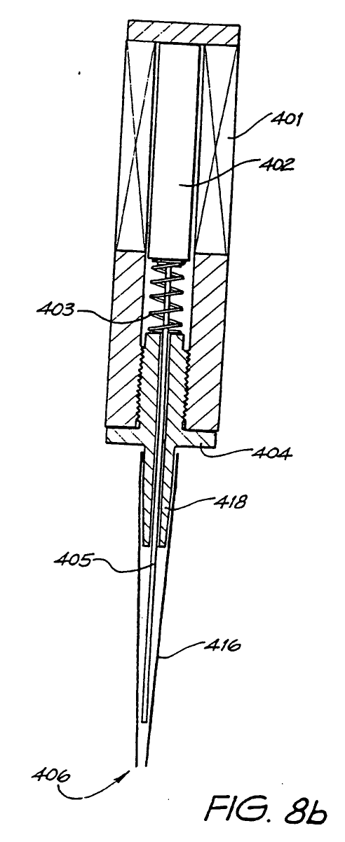

A first embodiment of the excision/cutting tool for use with the apparatus of FIG. 7 is shown in FIG. 8a.

The cutting tool comprises a cylindrical body portion 400, which has an upper end 400A and a lower end 400B. The body portion is a generally cylindrical tube defining a central bore 408 and call be made of metal or hard plastic or any suitable material.

The lower end 400B of the tube is closed with a end portion which acts as a tip holder 404 which has a central cylindrical bore in which is mounted a tip 409. The tip 409 has an annular cross section and has a wider cylindrical portion which locates inside the bore 408 of the body and after it emerges below the tip holder then tapers generally conically to a narrower portion which acts as a cutting head 406. The tip, and tip holder are fixed relative to the body portion.

The tip can be made of various materials including glass, metal or a plastic, such as polypropylene. However, it is preferable that the tip is translucent as this makes it possible to determine if acrylamide residue is caught inside the tip. The tip may be removable and disposable.

The pin is not illustrated in FIG. 8a but its upper end is fixed to an ejector magnet 402 and the lower end of the ejector pin should be at least 2 mm higher than the orifice of the cutting head when the ejector pin is in its uppermost, retracted or “home” position. A solenoid 401 surrounds the ejector magnetic 402. A “spring” magnet 410 having a central bore along which the ejector pin is free to move is disposed between the ejector magnet 408 and the tip portion 404. The spring magnet 410 is oriented so that it repels the ejector magnet 402 upwards so that the ejector pin is normally retracted. However, in use, after the cutting head has been lowered onto a sample and has cut a sample from the gel or other base, activation of the solenoid 410 forces the ejector magnet downwards which in turn forces the cutting pin downwards and ejects the cut sample held in the cutting head.

When power is removed from the solenoid, the ejector magnet once again is repelled upwards by the spring magnet 410.

FIG. 8b shows an alternative arrangement in which a spring 403 is used to keep the ejector magnet 402 in the “up” position instead of a magnet. In that embodiment, the solenoid 401 of the cutting tool body 400 is activated which drives the ejector magnet 402 down onto a spring mechanism 403. This forces the ejector pin 405 through the cutting head orifice 406 ejecting the sample into a microtitre plate. When the solenoid is deactivated the ejector magnet 402 is forced back up into the solenoid body by the expansion of the spring 403.

The cutting tip 416 shown in FIG. 8b is disposable and is generally conical, with a gentle taper and an annular cross-section. It pushes or snap-fits onto a conical protrusion 418 depending from the body 400.

The cutting tool should be of sufficient length so that the ejector pin is at least 2 mm higher than the orifice of the cutting head when the ejector magnet is in the home position

The ejector pin should protrude from the cutting tool orifice by at least 1 mm when the ejector magnet is forced down by the activation of the solenoid.

In one alternative version of the invention the cutting tool rotates about its central longitudinal axis to facilitate cutting of the sample. To enable this, the tool may be mounted on a screw thread extending in the z axis direction.

As with the first embodiment illustrated in FIGS. 1 to 6, it is also possible to image the gel independently of the cutting apparatus, identify the coordinates of the spots to be excised and then transform the coordinates into robot xy coordinates. The gel is scanned and then transferred from the scanner onto the cutting table. To determine the coordinates so that the robot now knows where to cut, the robot is taught four landmarks, preferably the points that are the furthest NE, SE, NW and SW on the gel. This will derive a function which we can then transform the image derived coordinates into robotic coordinates. The xy data file is then used by the robot software to excise the spots.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1.-5. (canceled)

6. A cutting tool comprising:
a cutting head defining a central bore adapted to cut and retain a sample of material;
a plunger disposed in the bore defining a rod which is disposed in and movable along the bore, the plunger being either formed of a ferro-magnetic material or having a portion of ferro-magnetic material attached thereto; and
a solenoid disposed around the plunger or ferromagnetic material wherein operation of the solenoid causes the plunger to move to eject the sample of material from the cutting head.

7. A cutting tool comprising:
(a) a cutting tip means having a bore therethrough;
(b) a cutting tip holder for holding the cutting tip means;
(c) an ejector pin, one end of which is disposed in bore of the cutting tip, the pin being moveable along the bore of the cutting tip;
(d) a magnet or a piece of ferromagnetic material integral with or attached to the ejector pin distal from the one end;
(e) a solenoid disposed around the magnet or ferro magnetic material for causing the pin to move in the bore in a direction which expels material from the cutting tip when the solenoid is energised; and
(f) return means for causing the pin to move in the opposite direction when the solenoid is not energised.

8. The cutting tool of claim 7 wherein a magnet is attached to the ejector pin distal from the one end and wherein the return means is also a magnet.

9. The cutting tool of claim 7 wherein the return means is a spring.

10. The cutting tool of claim 7 wherein the cutting tip is removable and disposable.

11. The cutting tool of claim 7 wherein the cutting tool includes a body portion comprising a generally cylindrical tube defining a central bore, in which the solenoid is disposed, with the lower end of the bore being closed by the cutting tip holder.

12. The cutting tool of claim 7 wherein the cutting tip has an annular cross section with a wider cylindrical portion which locates inside of the central bore of the body portion and tapers in a generally conical fashion to a narrow portion which forms the cutting head, the tip being made of a translucent material.
